(19) United States
(12) Patent Application Publication
(10) Pub. No.: US 2026/0179969 A1
(43) Pub. Date: Jun. 25, 2026

(54) POWER STORAGE CELL

(71) Applicant: TOYOTA JIDOSHA KABUSHIKI KAISHA, Toyota-shi (JP)

(72) Inventors: Satoshi NAKASHIMA, Toyota-shi (JP); Yosuke SHIMURA, Nagakute-shi (JP); Kenichi KAKISHITA, Nagoya-shi (JP); Masashi CHIHARA, Nagoya-shi (JP); Hiroki AWANO, Susono-shi (JP); Masaya OGURA, Hamamatsu-shi (JP); Ryosuke SATO, Toyota-shi (JP); Yasuaki NAGANO, Kosai-shi (JP)

(73) Assignee: TOYOTA JIDOSHA KABUSHIKI KAISHA, Toyota-shi (JP)

(21) Appl. No.: 19/395,463

(22) Filed: Nov. 20, 2025

(30) Foreign Application Priority Data
Dec. 20, 2024 (JP) 2024-225470

(51) Int. Cl. H01M 4/75; H01M 10/0587

(52) U.S. Cl. CPC H01M 4/75; H01M 10/0587

(57) ABSTRACT

A power storage cell is a power storage cell that is a secondary battery, and includes a first electrode, a second electrode, and a separator. The second electrode includes a second current collector. The second current collector includes a porous portion having a porous structure. The first electrode includes a first current collector. The first current collector includes a porous portion having a porous structure.

### CROSS REFERENCE TO RELATED APPLICATIONS

This nonprovisional application is based on Japanese Patent Application No. 2024-225470 filed on Dec. 20, 2024 with the Japan Patent Office, the entire contents of which are hereby incorporated by reference.

### BACKGROUND

### Field

The present disclosure relates to a power storage cell.

### Description of the Background Art

Japanese Patent Laying-Open No. 2020-198290 discloses a cell provided with a current collector including an organic support layer and a conductive layer provided on the organic support layer. An active material layer is provided on a surface of the current collector.

### SUMMARY

According to above-referenced Japanese Patent Laying-Open No. 2020-198290, the active material layer is provided on a surface of the current collector as described above. The active material layer may expand (contract) during charging/discharging of the cell. In this case, there is a possibility that the active material layer (electrode active material layer) is separated or the current collector is broken, for the reason that the current collector (conductive sheet) cannot adapt to expansion (contraction) of the active material layer.

The present disclosure is made to solve the above problem, and an object thereof is to provide a power storage cell that enables a conductive sheet to adapt to expansion (contraction) of an electrode active material layer.

A power storage cell according to one aspect of the present disclosure is a power storage cell that is a secondary battery, and includes: a first electrode sheet; a second electrode sheet stacked on the first electrode sheet; and a separator placed between the first electrode sheet and the second electrode sheet. At least one of the first electrode sheet and the second electrode sheet includes: a conductive sheet; and an electrode active material layer formed on the conductive sheet. The conductive sheet includes a porous portion having a porous structure.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a configuration of a power storage device and a frame member according to the present embodiment.

FIG. 2 is a perspective view showing a configuration of the power storage cell according to the present embodiment.

FIG. 3 is an exploded perspective view showing the configuration of the power storage cell according to the present embodiment.

FIG. 4 is a cross-sectional view of an electrode assembly according to the present embodiment.

FIG. 5 is a cross-sectional view illustrating a configuration of a first tab and a first electrode according to the present embodiment.

FIG. 6 is a cross-sectional view illustrating a configuration of a second electrode according to the present embodiment.

FIG. 7 is a partially enlarged view of the second electrode of FIG. 6.

FIG. 8 is a cross-sectional view of the second electrode in a state where winding is unwound.

FIG. 9 is a partially enlarged view of the first electrode of FIG. 5.

FIG. 10 is a cross-sectional view of the first electrode in a state where winding is unwound.

FIG. 11 is a cross-sectional view of a second electrode according to a first modification of the present embodiment.

FIG. 12 is a cross-sectional view of a second electrode according to a second modification of the present embodiment.

FIG. 13 is a cross-sectional view of a second electrode according to a third modification of the present embodiment.

FIG. 14 is a cross-sectional view of a second electrode according to a fourth modification of the present embodiment.

FIG. 15 is a cross-sectional view of a first electrode according to a fifth modification of the present embodiment.

### DESCRIPTION OF THE PREFERRED EMBODIMENTS

Embodiments of the present disclosure will be described with reference to the drawings. In the drawings referred to below, the same or corresponding members are denoted by the same reference numerals.

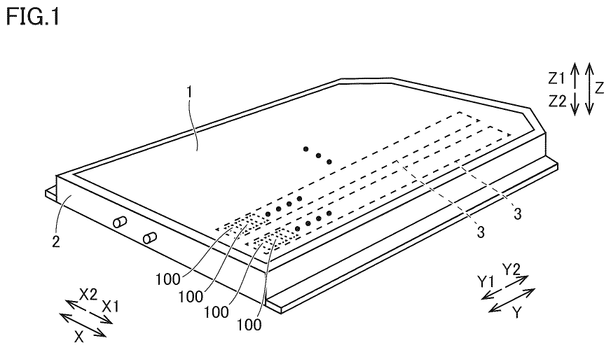

FIG. 1 is a perspective view illustrating a configuration of a power storage device 1 including a power storage cell 100 according to an embodiment of the present disclosure. The power storage device 1 is mounted on, for example, a vehicle (not shown). Examples of the vehicle include a hybrid electric vehicle, a plug-in hybrid electric vehicle, and a battery electric vehicle. The power storage device 1 may be provided in an electric device (for example, a stationary power storage device) other than the electrically powered vehicle.

Note that the X direction, the Y direction, and the Z direction in this specification are directions orthogonal to each other. For example, the X direction and the Y direction may be the front-rear direction and the left-right direction when the power storage device 1 is mounted on an electrically powered vehicle, respectively. The Z direction may be the vertical direction. Specifically, the Z1 direction and the Z2 direction may be upward and downward, respectively.

The power storage device 1 is attached to a frame member 2 provided at the bottom of the vehicle. The frame member 2 is formed in a substantially quadrangular cylindrical shape surrounding the power storage device 1.

The power storage device 1 includes a plurality of power storage stacks 3. Each of the power storage stacks 3 is formed in a rectangular parallelepiped shape elongated in the Y direction. The plurality of power storage stacks 3 are arranged side by side along the X direction. Each power storage stack 3 includes a plurality of power storage cells 100 arranged in the Y direction. In FIG. 1, for simplification, only two power storage stacks 3 are illustrated, and only three power storage cells 100 in each power storage stack 3 are illustrated.

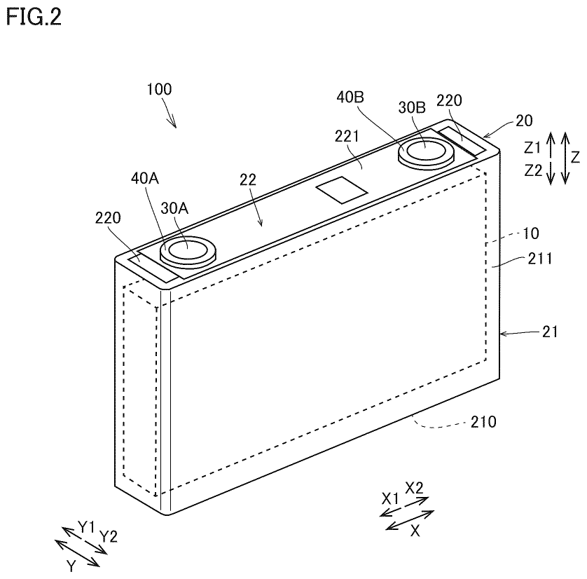

FIG. 2 is a perspective view illustrating the power storage cell 100 according to the present embodiment. As shown in FIG. 2, the power storage cell 100 is a so-called prismatic shape battery. The power storage cell 100 is a secondary battery configured to be chargeable and dischargeable. The power storage cell 100 may be a secondary battery such as a lithium ion battery or a nickel-metal hydride battery. The power storage cell 100 can be used, for example, as a cell included in a power storage module mounted on an electrically powered vehicle.

The power storage cell 100 includes an electrode assembly 10, a case 20, a first external terminal 30A, a second external terminal 30B, a first terminal support portion 40A, and a second terminal support portion 40B. In FIG. 2, the electrode assembly 10 is schematically shown by a broken line.

The case 20 has conductivity. The conductive portion of the case 20 is made of metal such as aluminum. The case 20 accommodates the electrode assembly 10. The case 20 also accommodates an electrolyte solution (not shown).

The case 20 includes a case body 21 and a lid 22. The case body 21 includes a bottom wall 210 and a peripheral wall 211 rising from the bottom wall 210.

The lid 22 includes a lid body 220 and an insulating cover 221. The lid body 220 is joined to the peripheral wall 211 by welding or the like so as to close the opening of the peripheral wall 211.

The first external terminal 30A and the second external terminal 30B are provided so as to be exposed to the outside in the power storage cell 100. In the present embodiment, the first external terminal 30A is a positive electrode terminal, and the second external terminal 30B is a negative electrode terminal. The first external terminal 30A and the second external terminal 30B are arranged in the X direction.

The first terminal support portion 40A is locked to the lid body 220. The first terminal support portion 40A supports the first external terminal 30A from the outer peripheral side of the first external terminal 30A. The second terminal support portion 40B is locked to the lid body 220. The second terminal support portion 40B supports the second external terminal 30B from the outer peripheral side of the second external terminal 30B.

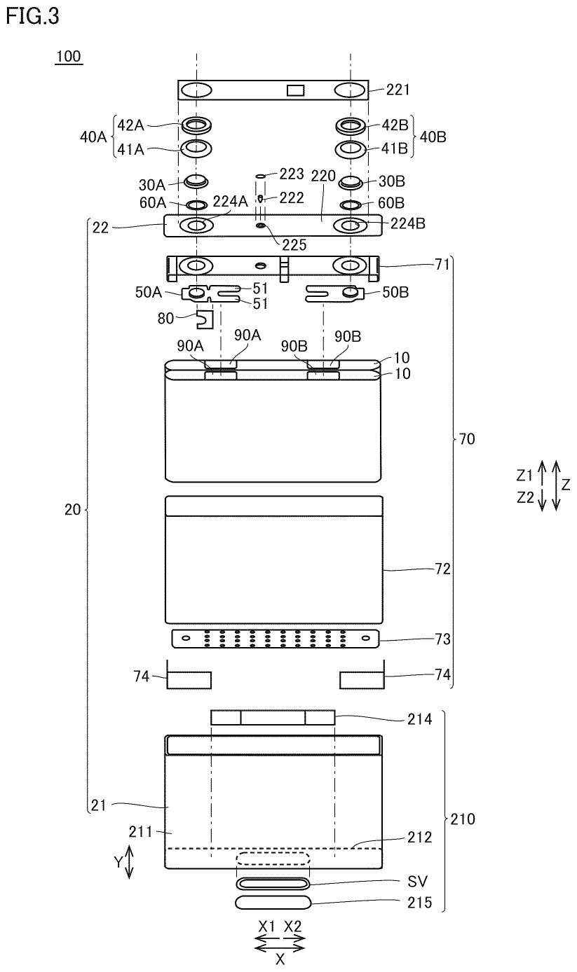

FIG. 3 is an exploded perspective view of the power storage cell 100 according to the present embodiment. The power storage cell 100 further includes a first coupling member 50A, a second coupling member 50B, a first seal ring 60A, a second seal ring 60B, an insulating member 70, and a fuse protection portion 80.

The bottom wall 210 includes a bottom body 212, an inner protective film 214, and an outer protective film 215. The peripheral wall 211 stands from the bottom body 212. The bottom body 212 is provided with a pressure release valve SV. The outer protective film 215 covers the pressure release valve SV from the outside. The inner protective film 214 covers the pressure release valve SV from the inside. The bottom body 212 and the pressure release valve SV are made of metal such as aluminum.

An opening is formed in an upper end of the peripheral wall 211. The peripheral wall 211 has a substantially rectangular outer shape when viewed from the opening direction of the opening. The opening and the bottom wall 210 are arranged in the Z direction. The opening is disposed on the Z1 side of the bottom wall 210. The Z direction may be a height direction or a vertical direction of the power storage cell 100. The peripheral wall 211 is made of a metal such as aluminum.

The lid 22 further includes a sealing plug 222 and a plug cover 223. A first coupling hole 224A, a second coupling hole 224B, and a liquid injection hole 225 are formed in the lid body 220. The liquid injection hole 225 is a through hole for injecting the electrolyte solution into the case body 21 in the manufacturing process of the power storage cell 100.

The sealing plug 222 seals the liquid injection hole 225. The plug cover 223 covers the liquid injection hole 225 and the sealing plug 222. The insulating cover 221 covers the liquid injection hole 225, the sealing plug 222, and the plug cover 223.

The first coupling member 50A and the second coupling member 50B have conductivity. At least a part of the first coupling member 50A and the second coupling member 50B is disposed in the case 20. Each of the first coupling member 50A and the second coupling member 50B is disposed at a position facing the electrode assembly 10 in the Z direction. Each of the first coupling member 50A and the second coupling member 50B is disposed on the Z1 side of the electrode assembly 10.

The first external terminal 30A or the first coupling member 50A is inserted into the first coupling hole 224A. The first external terminal 30A and the first coupling member 50A are joined to each other. The first coupling member 50A is joined to the electrode assembly 10. Thus, the first external terminal 30A is electrically connected to the electrode assembly 10.

The second external terminal 30B or the second coupling member 50B is inserted into the second coupling hole 224B. The second external terminal 30B and the second coupling member 50B are joined to each other. The second coupling member 50B is joined to the electrode assembly 10. Thus, the second external terminal 30B is electrically connected to the electrode assembly 10.

The first seal ring 60A is provided along the first coupling hole 224A. The first seal ring 60A is provided in a gap between the lid body 220 and the first external terminal 30A, and seals the gap. The second seal ring 60B is provided along the second coupling hole 224B. The second seal ring 60B is provided in a gap between the lid body 220 and the second external terminal 30B, and seals the gap. The first seal ring 60A and the second seal ring 60B have electrical insulation properties.

The first terminal support portion 40A includes a first locking ring 41A and a first covering ring 42A. The first locking ring 41A extends annularly so as to surround the first coupling hole 224A, and directly locks with the lid body 220. The first covering ring 42A covers the first locking ring 41A. The first locking ring 41A supports the first external terminal 30A via the first covering ring 42A. The first covering ring 42A is made of a resin member having electrical insulation properties or relatively weak electrical conductivity.

The second terminal support portion 40B includes a second locking ring 41B and a second covering ring 42B. The second locking ring 41B extends annularly so as to surround the second coupling hole 224B, and directly locks with the lid body 220. The second covering ring 42B covers the second locking ring 41B. The second locking ring 41B supports the second external terminal 30B via the second covering ring 42B. The second covering ring 42B is made of a resin member having electrical insulation properties.

The insulating member 70 has electrical insulation properties. The insulating member 70 is disposed between the electrode assembly 10 and the case 20. The insulating member 70 electrically insulates the electrode assembly 10 and the case 20 from each other. The insulating member 70 includes an insulating bracket 71, a peripheral surface insulating portion 72, a bottom surface insulating portion 73, and an adhesive tape 74.

The insulating bracket 71 is disposed between the electrode assembly 10 and the lid body 220. The insulating bracket 71 has relatively high rigidity and is in contact with both the electrode assembly 10 and the lid body 220. Thus, the electrode assembly 10 is fixed to the case 20 in the Z direction.

The peripheral surface insulating portion 72 is disposed between the electrode assembly 10 and the peripheral wall 211. The electrode assembly 10 is formed of a film-shaped member.

The bottom surface insulating portion 73 is disposed between the electrode assembly 10 and the bottom wall 210. The bottom surface insulating portion 73 is formed of a film-like member. The bottom surface insulating portion 73 is fixed (adhered) to the case 20 (bottom wall 210) by an adhesive tape 74.

The power storage cell 100 according to the present embodiment includes a plurality of electrode assemblies 10. The power storage cell 100 of the present embodiment includes two electrode assemblies 10. The electrode assemblies 10 are arranged in the Y direction. The peripheral surface insulating portion 72 may integrally cover the plurality of electrode assemblies 10 so that the electrode assemblies 10 are fixed to each other.

Each of the plurality of electrode assemblies 10 is provided with at least one first tab 90A and at least one second tab 90B. In the present embodiment, each of the plurality of electrode assemblies 10 is provided with a plurality of first tabs 90A and a plurality of second tabs 90B. Each of the first tabs 90A electrically connects a first electrode (first electrode sheet) 10A to be described later to the first coupling member 50A. Each second tab 90B electrically connects a second electrode (second electrode sheet) 10B to be described later and the second coupling member 50B.

The plurality of first tabs 90A are arranged side by side in the Y direction. The plurality of first tabs 90A are joined to each other by, for example, ultrasonic welding. The plurality of first tabs 90A are joined to the first coupling member 50A by, for example, ultrasonic welding. The plurality of second tabs 90B are arranged side by side in the Y direction. The plurality of second tabs 90B are joined to each other by, for example, ultrasonic welding. The plurality of second tabs 90B are joined to the second coupling member 50B by, for example, ultrasonic welding.

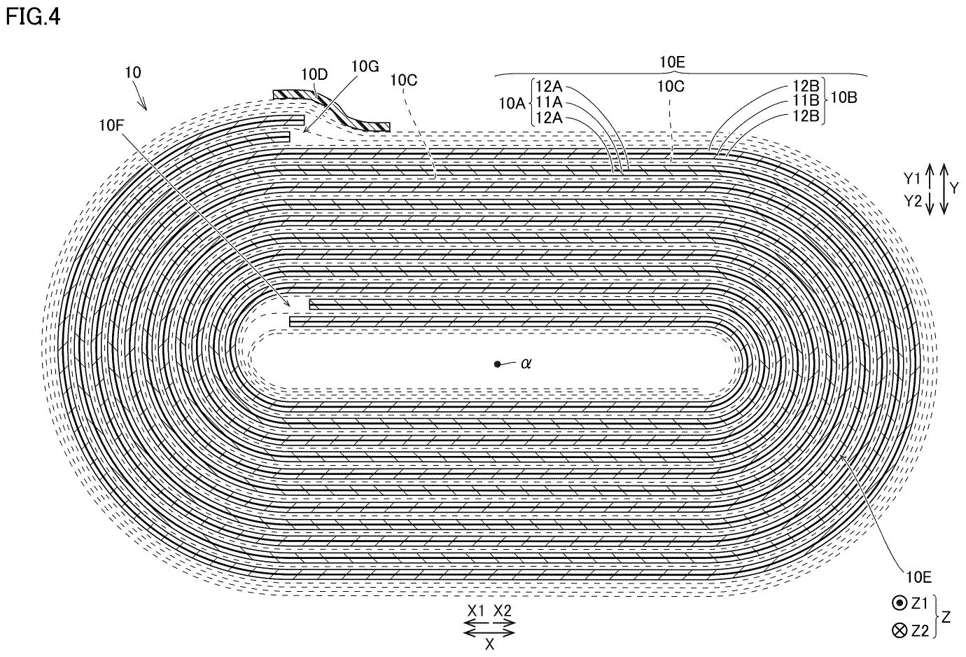

FIG. 4 is a cross-sectional view of the electrode assembly 10 in the XY plane. The electrode assembly 10 includes a first electrode 10A, a second electrode 10B, a separator 10C, and a tape member 10D. It is wound so as to surround the winding axis α. As described above, in the present embodiment, the electrode assembly 10 is a so-called wound electrode assembly. The electrode assembly 10 may be a multilayer electrode assembly in which the first electrode 10A, the second electrode 10B, and the separator 10C are stacked in one direction (for example, the Y direction). The first electrode 10A and the second electrode 10B are examples of the “first electrode sheet” and the “second electrode sheet” in the present disclosure, respectively.

The first electrode 10A and the second electrode 10B each have a sheet-like outer shape. The second electrode 10B is stacked on the first electrode 10A. Specifically, the second electrode 10B is stacked on the first electrode 10A with the separator 10C interposed between the first electrode 10A and the second electrode.

The electrode assembly 10 is configured by an electrode plate group in which a first electrode 10A and a second electrode 10B are wound with one or more separators 10C interposed therebetween. Specifically, the electrode assembly 10 is provided with a multilayer sheet 10E including a first electrode 10A, a second electrode 10B, and a separator 10C. The multilayer sheet 10E is wound so as to surround the winding axis α.

The multilayer sheet 10E has an inner end 10F and an outer end 10G. The inner end 10F means the beginning of the winding of the multilayer sheet 10E. The outer end 10G means the end of the winding of the multilayer sheet 10E. In the present specification, a direction from the inner end 10F side toward the outer end 10G side is referred to as an extending direction of multilayer sheet 10E (hereinafter, only the extending direction will be described). The extending direction is synonymous with the winding direction of multilayer sheet 10E.

In the present embodiment, the first electrode 10A is a positive electrode, and the second electrode 10B is a negative electrode. However, the first electrode 10A may be a negative electrode, and the second electrode 10B may be a positive electrode.

The separator 10C separates the first electrode 10A and the second electrode 10B while allowing ions to move between the first electrode 10A and the second electrode 10B. The ions are, for example, lithium ions. The separator 10C has electrical insulation properties.

Among the first electrode 10A, the second electrode 10B, and the separator 10C, the separator 10C is located on the innermost side with respect to the winding axis α. Among the first electrode 10A, the second electrode 10B, and the separator 10C, the separator 10C is located on the outermost side with respect to the winding axis α. An end edge of the separator 10C on the outer peripheral side in the extending direction (a portion of the separator 10C corresponding to the outer end 10G) is fixed by a tape member 10D disposed on the outer peripheral surface of the separator 10C.

The first electrode 10A includes a first current collector (conductive sheet) 11A and a first active material layer (electrode active material layer) 12A. The second electrode 10B includes a second current collector (conductive sheet) 11B and a second active material layer (electrode active material layer) 12B. The first current collector 11A and the first active material layer 12A are examples of the “conductive sheet” and the “electrode active material layer” of the present disclosure, respectively. The second current collector 11B and the second active material layer 12B are examples of the “conductive sheet” and the “electrode active material layer” of the present disclosure, respectively.

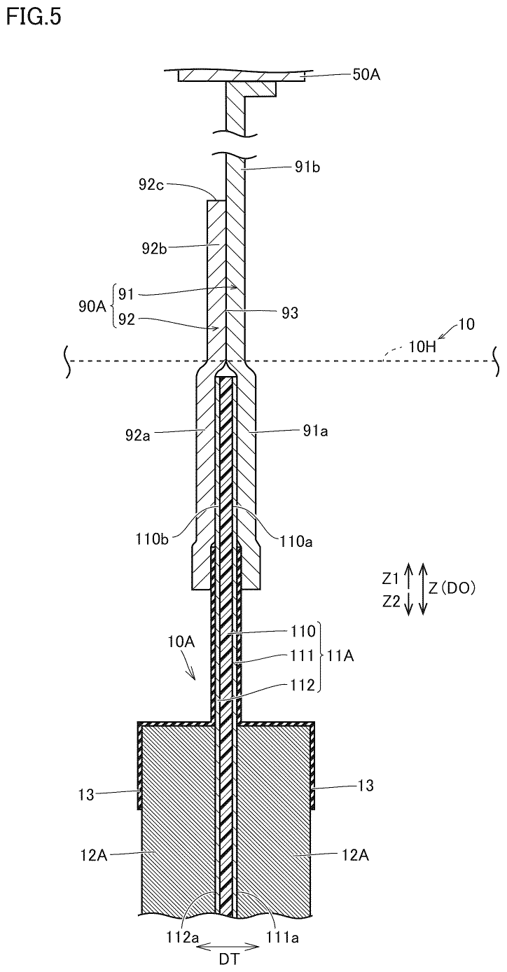

FIG. 5 is a cross-sectional view of the first electrode 10A and the first tab 90A. The first current collector 11A includes an insulating support layer 110, a first conductive layer (solid portion) (first solid portion) 111, and a second conductive layer (solid portion) (second solid portion) 112. The first electrode 10A further includes a protective portion 13.

The first conductive layer 111 has a surface 111a. The surface 111a is a surface opposite to the insulating support layer 110. The second conductive layer 112 has a surface 112a. The surface 112a is a surface opposite to the insulating support layer 110. The first active material layer 12A is formed on each of the surface 111a and the surface 112a. The upper end edge of the first active material layer 12A is separated from each of the plurality of first tabs 90A.

The insulating support layer 110 (a porous portion 110c described later) has an inner surface (first surface) 110a and an outer surface (second surface) 110b. The inner surface 110a is a surface of the insulating support layer 110 disposed on the winding axis α side. The surface disposed on the winding axis α side means a surface disposed facing the winding axis α side. The outer surface 110b is a surface disposed opposite to the inner surface 110a (winding axis α). The inner surface 110a and the outer surface 110b are examples of the “first surface” and the “second surface” of the present disclosure, respectively.

The insulating support layer 110 is made of a resin composition having electrical insulation properties. For example, the insulating support layer 110 is made of a resin composition including a polyester-based resin. The polyester-based resin is preferably polyethylene terephthalate, for example. This makes it possible to increase the rigidity of the first current collector 11A while maintaining the electrical insulation of the insulating support layer 110. Thus, the insulating support layer 110 can be made relatively thin. The orthogonal direction DO crossing (orthogonal to) the thickness direction DT of the insulating support layer 110 is substantially parallel to the Z direction. The thickness direction DT and the orthogonal direction DO are examples of the “stacking direction” and the “crossing direction” in the present disclosure, respectively.

The first conductive layer 111 is formed on the inner surface 110a. The first conductive layer 111 may be provided over the entire inner surface 110a of the insulating support layer 110.

The second conductive layer 112 is formed on the outer surface 110b. The second conductive layer 112 may be provided over the entire outer surface 110b of the insulating support layer 110.

Each of the first conductive layer 111 and the second conductive layer 112 is formed of a metal layer. Each of the first conductive layer 111 and the second conductive layer 112 is made of a metal containing aluminum. Thus, the first current collector 11A can be suitably used as a positive electrode current collector. The first current collector 11A may be a negative electrode current collector, and the first conductive layer 111 and the second conductive layer 112 may be made of a metal including copper.

Each of the plurality of first tabs 90A is bonded to the first conductive layer 111 and the second conductive layer 112 by ultrasonic welding, for example. Each of the plurality of first tabs 90A extends from the insulating support layer 110 toward the Z1 side.

Each of the plurality of first tabs 90A includes a first foil portion 91 and a second foil portion 92. The first foil portion 91 is located on the opposite side of the insulating support layer 110 from the first conductive layer 111. The first foil portion 91 is bonded to the first conductive layer 111. The first foil portion 91 is bonded to the first coupling member 50A. The second foil portion 92 is located on the opposite side of the insulating support layer 110 from the second conductive layer 112. The second foil portion 92 is bonded to the second conductive layer 112.

The first foil portion 91 includes a lower portion 91a and an upper portion 91b. The lower portion 91a is a portion of the first foil portion 91 disposed on the first current collector 11A. The upper portion 91b protrudes from the lower portion 91a toward the Z1 side (the first coupling member 50A side).

The second foil portion 92 includes a lower portion 92a and an upper portion 92b. The lower portion 92a is a portion of the second foil portion 92 disposed on the first current collector 11A. The upper portion 92b protrudes from the lower portion 92a toward the Z1 side (to the first coupling member 50A).

The upper portion 91b is joined to the upper portion 92b. Specifically, the upper portion 91b and the upper portion 92b are bonded to each other by ultrasonic welding, for example, at a bonding portion 93 closer to the Z1 side than the first current collector 11A.

The first foil portion 91 (upper portion 91b) extends further toward the Z1 side than the upper end portion 92c (end portion on the Z1 side) of the second foil portion 92 (upper portion 92b). The bonding portion 93 is a portion where the upper portion 92b and the root portion of the upper portion 91b on the Z2 side are bonded to each other. The bonding portion 93 extends, for example, from the upper end portion 10H of the electrode assembly 10 toward the Z1 side. The upper end portion 10H of the electrode assembly 10 is an upper end portion of the separator 10C (FIG. 4). The lower end portion of the bonding portion 93 may be located on the Z1 side or the Z2 side with respect to the upper end portion 10H, for example.

As described above, the length of the first foil portion 91 in the orthogonal direction DO (Z direction) orthogonal to the thickness direction DT is longer than the length of the second foil portion 92 in the orthogonal direction DO. However, the aspect of the first tab 90A is not limited thereto. The length of the second foil portion 92 in the orthogonal direction DO may be longer than the length of the first foil portion 91 in the orthogonal direction DO. The second foil portion 92 may be joined to the first coupling member 50A, and the first foil portion 91 may not be joined to the first coupling member 50A.

The separator 10C is stacked on the first active material layer 12A in a radial direction centered on the winding axis α (FIG. 4).

The protective portion 13 has electrical insulation properties. The protective portion 13 is made of, for example, ceramic. The protective portion 13 covers the upper portion of the first active material layer 12A. The protective portion 13 further covers the first current collector 11A between the first tab 90A and the first active material layer 12A.

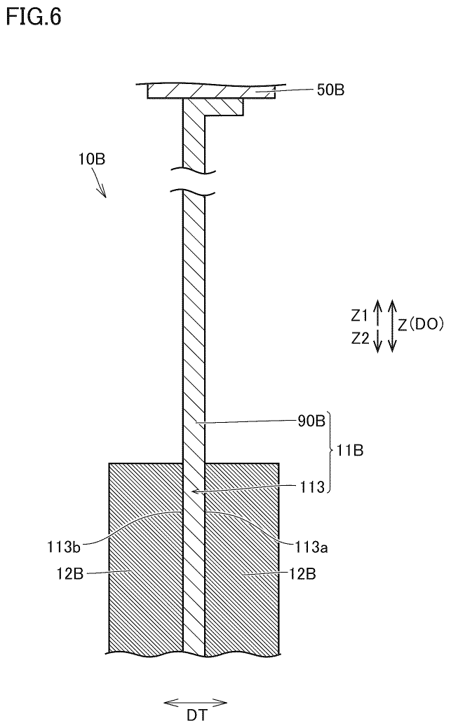

FIG. 6 is a cross-sectional view of the second electrode 10B. The second electrode 10B is stacked on the first active material layer 12A (FIG. 4) via the separator 10C (FIG. 4) in the radial direction.

The second electrode 10B includes a second current collector 11B and a second active material layer 12B. The second current collector 11B includes a conductive support portion 113 and a plurality of second tabs 90B. The conductive support portion 113 extends along the orthogonal direction DO (Z direction). The plurality of second tabs 90B extend from the upper end of the conductive support portion 113. The plurality of second tabs 90B are joined to each other by ultrasonic welding and joined to the second coupling member 50B.

The plurality of second tabs 90B and the conductive support portion 113 are formed of an integral member, and are formed of, for example, a metal foil. In the present embodiment, the plurality of second tabs 90B and the conductive support portion 113 are made of a metal including copper, for example. Thus, the second current collector 11B can be suitably used as a negative electrode current collector. When the first current collector 11A is a negative electrode current collector, the plurality of second tabs 90B and the conductive support portion 113 may be made of a metal including aluminum.

The conductive support portion 113 has an inner surface (first surface) 113a and an outer surface (second surface) 113b. The inner surface 113a is a surface of the conductive support portion 113 disposed on the winding axis α side. The outer surface 113b is a surface disposed on the opposite side to the inner surface 113a (winding axis α). The inner surface 113a and the outer surface 113b are examples of the “first surface” and the “second surface” in the present disclosure, respectively.

The second active material layer 12B is stacked on each of the inner surface 113a and the outer surface 113b of the conductive support portion 113. In the present embodiment, since the second electrode 10B is a negative electrode, the edge of the second active material layer 12B on the Z1 side is located closer to the Z1 side than the edge of the first active material layer 12A on the Z1 side. The Z2-side edge of the second active material layer 12B is located closer to the Z2 side than the Z2-side edge of the first active material layer 12A.

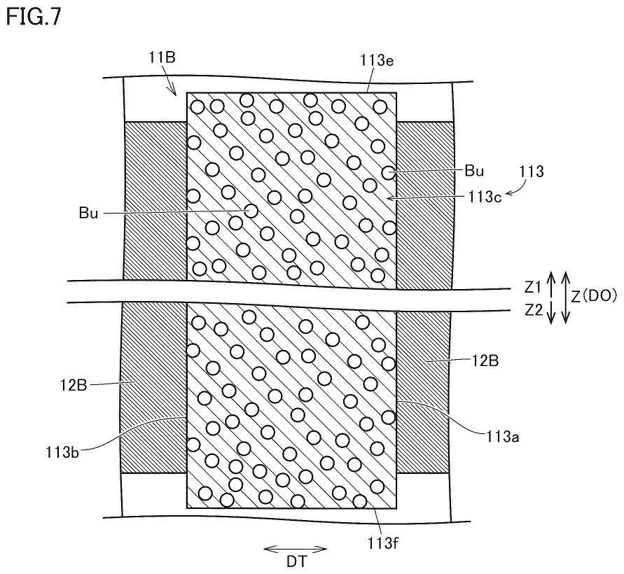

FIG. 7 is a schematic partial enlarged cross-sectional view of the conductive support portion 113 and the second active material layer 12B. Although FIG. 7 shows a cross section at a position where the second tab 90B (FIG. 6) is not provided, the same configuration may be employed at a position where the second tab 90B is provided.

Here, in a conventional power storage cell, when the active material layer expands (contracts) during charge and discharge, the conductive sheet cannot adapt to the expansion (contraction) of the active material layer, which may cause separation of the active material layer or deformation (breakage) of the conductive sheet.

In the present embodiment, the second current collector 11B (conductive support portion 113) has a porous portion 113c. The porous portion 113c has a porous structure in which a plurality of bubbles Bu are formed. As a result, the conductive support portion 113 can more effectively adapt to the expansion (contraction) of the second active material layer 12B as compared with the case where the conductive support portion 113 is solid.

Specifically, the density of the bubbles Bu in the conductive support portion 113 may be uniform. That is, the bubble Bu is also formed at a position in contact with the inner surface 113a and at a position in contact with the outer surface 113b. The conductive support portion 113 has an end portion 113e on the Z1 side and an end portion 113f on the Z2 side. The bubble Bu is also formed at a position in contact with the end portion 113e and at a position in contact with the end portion 113f.

The density of the bubbles Bu may vary depending on the position in the conductive support portion 113. For example, the density of the bubbles Bu may be relatively high in the vicinity of the inner surface 113a and the outer surface 113b.

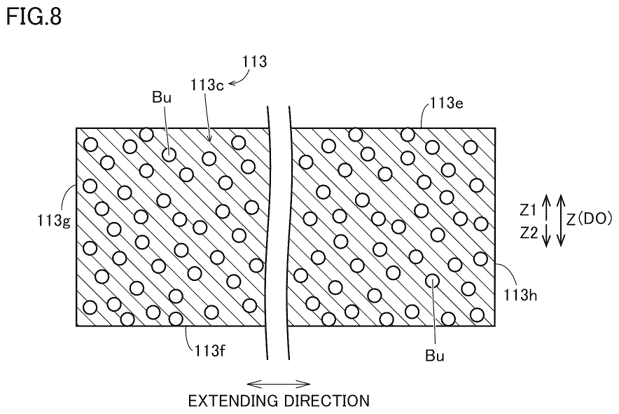

FIG. 8 is a cross-sectional view illustrating the conductive support portion 113 in a state where the winding is unwound. The conductive support portion 113 includes an inner end 113g and an outer end 113h. The inner end 113g is a part of the inner end 10F of the multilayer sheet 10E (FIG. 4). The outer end 113h is a part of the outer end 10G of the multilayer sheet 10E.

As shown in FIG. 8, the porous portion 113c extends in the extending direction. Specifically, the porous portion 113c extends from the position of the inner end 113g to the position of the outer end 113h. The porous portion 113c extends without interruption in the extending direction. This allows the conductive support portion 113 to adapt to the expansion (contraction) of the second active material layer 12B regardless of the position of the second active material layer 12B in the extending direction where the expansion (expansion/contraction) occurs.

Although not shown, the second foil portion 92 may also be formed with a porous portion in the same manner as the conductive support portion 113.

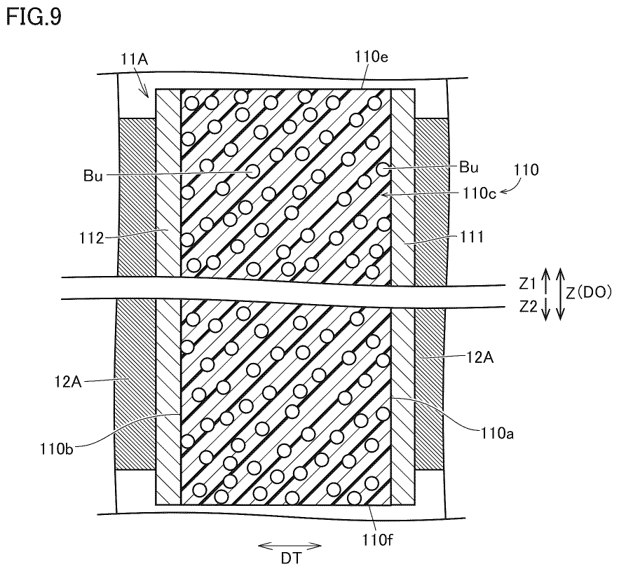

FIG. 9 is a schematic partial enlarged cross-sectional view of the first current collector 11A and the first active material layer 12A. Although FIG. 9 shows a cross section at a position where the first tab 90A (FIG. 5) is not provided, the same configuration may be employed at a position where the first tab 90A is provided.

The insulating support layer 110 has a porous portion 110c. The porous portion 110c has a porous structure in which a plurality of bubbles Bu are formed.

The density of the bubbles Bu in the insulating support layer 110 may be uniform. That is, the bubble Bu is also formed at a position in contact with the inner surface 110a and at a position in contact with the outer surface 110b. The insulating support layer 110 has an end portion 110e on the Z1 side and an end portion 110f on the Z2 side. The bubble Bu is also formed at a position in contact with the end portion 110e and at a position in contact with the end portion 110f.

Each of the first conductive layer 111 and the second conductive layer 112 does not have a porous structure in which bubbles are formed. In other words, each of the first conductive layer 111 and the second conductive layer 112 is solid. The first conductive layer 111 is an example of the “solid portion” and the “first solid portion” in the present disclosure. The second conductive layer 112 is an example of the “solid portion” and the “second solid portion” of the present disclosure.

Thus, the electrical resistance of the first conductive layer 111 and the second conductive layer 112 can be reduced as compared with the case where each of the first conductive layer 111 and the second conductive layer 112 has a porous structure.

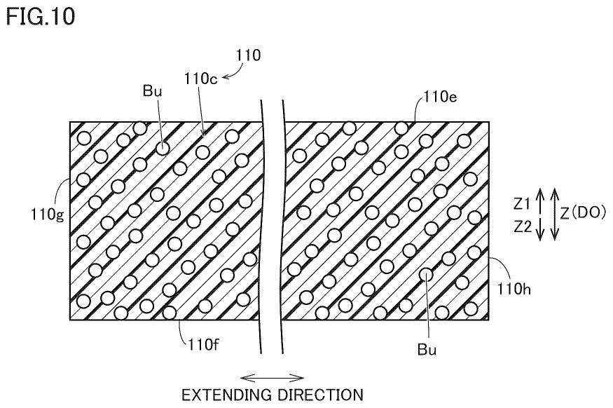

FIG. 10 is a cross-sectional view illustrating the insulating support layer 110 in a state in which winding is unwound. The insulating support layer 110 includes an inner end 110g and an outer end 110h. The inner end 110g is part of the inner end 10F of the multilayer sheet 10E (FIG. 4). The outer end 110h is a part of the outer end 10G of the multilayer sheet 10E.

As shown in FIG. 10, the porous portion 110c extends in the extending direction. Specifically, the porous portion 110c extends from the inner end 110g to the outer end 110h. The porous portion 110c extends without interruption in the extending direction.

As described above, in the present embodiment, the second current collector 11B (conductive support portion 113) has the porous portion 113c having a porous structure. The first current collector 11A (insulating support layer 110) has a porous portion 110c having a porous structure. Thus, when the first active material layer 12A and the second active material layer 12B expand (expand/contract) during charge and discharge of the power storage cell 100, the porous portion 113c (porous portion 110c) can be deformed to adapt to the expansion (expansion/contraction). In other words, the expansion (expansion/contraction) can be absorbed by the porous portion 113c (porous portion 110c). As a result, separation of the first active material layer 12A and the second active material layer 12B or breakage of the first current collector 11A and the second current collector 11B due to failure of the first current collector 11A and the second current collector 11B to adapt to expansion (contraction) of the first active material layer 12A and the second active material layer 12B can be suppressed.

Unlike the case where the conductive support portion 113 is solid, a part of the second active material layer 12B can penetrate into the porous portion 113c of the conductive support portion 113 when the second active material layer 12B is applied. As a result, separation of the second active material layer 12B can be suppressed.

In addition, the power storage cell 100 can be reduced in weight as compared with the case where the conductive support portion 113 (the insulating support layer 110) is solid.

### Modifications

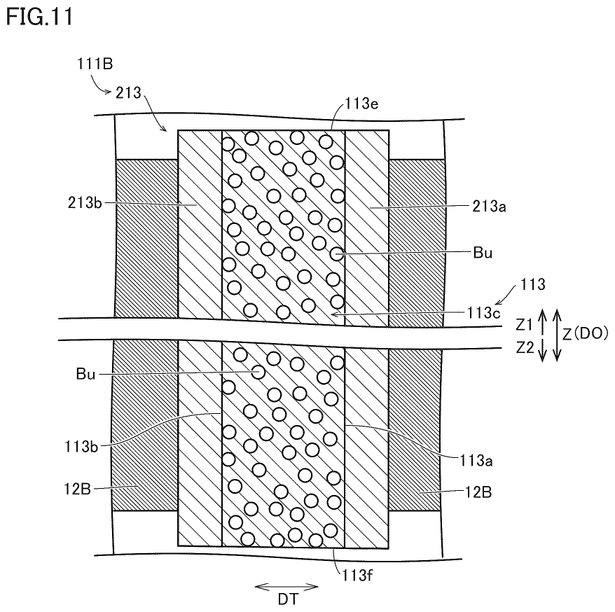

FIG. 11 shows a cross-sectional view of a second current collector (conductive sheet) 111B which is a modification of the second current collector 11B of the above embodiment. The second current collector 111B is different from the second current collector 11B in that it includes a first conductive layer (solid portion) (first solid portion) 213a and a second conductive layer (solid portion) (second solid portion) 213b. The second current collector 111B is an example of the “conductive sheet” in the present disclosure. The first conductive layer 213a is an example of the “solid portion” and the “first solid portion” in the present disclosure. The second conductive layer 213b is an example of the “solid portion” and the “second solid portion” in the present disclosure.

The conductive support portion 213 includes a conductive support portion 113, a first conductive layer 213a, and a second conductive layer 213b. Each of the first conductive layer 213a and the second conductive layer 213b is formed of the same material (that is, a metal including copper) as the conductive support portion 113. The first conductive layer 213a is formed on the inner surface 113a of the conductive support portion 113. The second conductive layer 213b is formed on the outer surface 113b of the conductive support portion 113. The second tab 90B may be formed in the same manner as the conductive support portion 213.

Each of the first conductive layer 213a and the second conductive layer 213b is a solid conductive layer in which no bubble is formed. Accordingly, the electrical resistance of the conductive support portion 213 can be reduced as compared with the case where the first conductive layer 213a and the second conductive layer 213b are not provided.

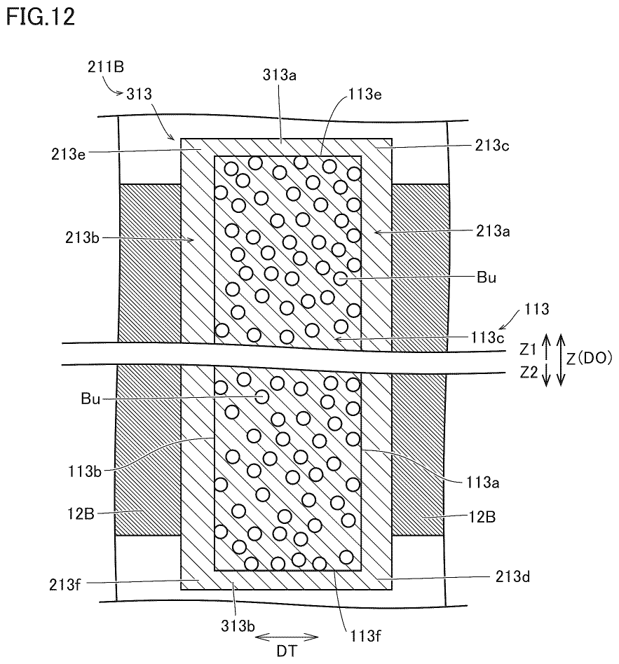

FIG. 12 shows a cross section of a second current collector (conductive sheet) 211B which is a modification of the second current collector 111B of FIG. 11. The second current collector 211B is different from the second current collector 111B in FIG. 11 in that the conductive support portion 313 is included instead of the conductive support portion 213. The second current collector 211B is an example of the “conductive sheet” in the present disclosure.

The conductive support portion 313 includes the conductive support portion 113, the first conductive layer 213a, the second conductive layer 213b, a connection portion (third solid portion) (solid portion) 313a, and a connection portion (third solid portion) (solid portion) 313b. Each of the connection portion 313a and the connection portion 313b is an example of the “solid portion” and the “third solid portion” in the present disclosure.

The first conductive layer 213a includes an end portion (first end portion) 213c on the Z1 side and an end portion (first end portion) 213d on the Z2 side. The second conductive layer 213b includes an end portion (second end portion) 213e on the Z1 side and an end portion (second end portion) 213f on the Z2 side. The connection portion 313a connects the end portion 213c and the end portion 213e. The connection portion 313b connects the end portion 213d and the end portion 213f. Each of the end portion 213c and the end portion 213d is an example of the “first end portion” in the present disclosure. Each of the end portion 213e and the end portion 213f is an example of the “second end portion” in the present disclosure.

Similarly to the first conductive layer 213a and the second conductive layer 213b, each of the connection portion 313a and the connection portion 313b is solid without air bubbles formed therein. Each of the connection portion 313a and the connection portion 313b is formed integrally with each of the first conductive layer 213a and the second conductive layer 213b.

Thus, since the first conductive layer 213a and the second conductive layer 213b are connected by the connection portion 313a and the connection portion 313b by the connection portion 313a and the connection portion 313b, it is possible to suppress separation of each of the first conductive layer 213a and the second conductive layer 213b from the conductive support portion 113.

The connection portion 313a may be in close contact with the end portion 113e of the conductive support portion 113. The connection portion 313b may be in close contact with the end portion 113f of the conductive support portion 113.

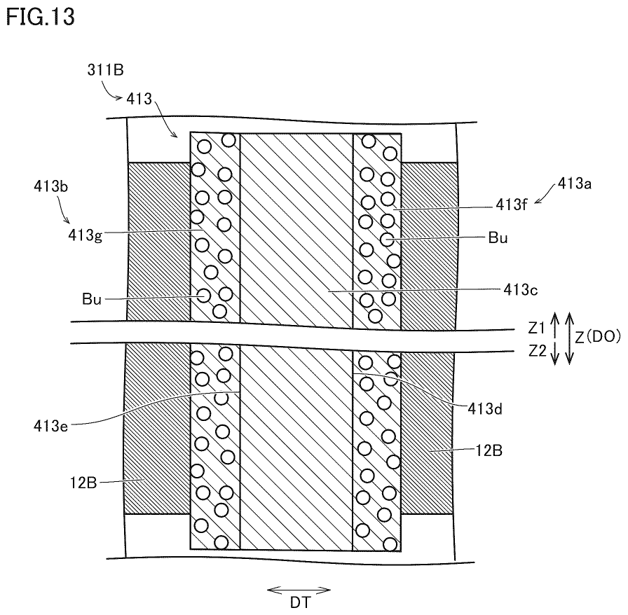

FIG. 13 is a cross-sectional view of a second current collector (conductive sheet) 311B which is a modification of the second current collector 111B of FIG. 11. The second current collector 311B is different from the second current collector 111B in FIG. 11 in that a conductive support portion 413 is included instead of the conductive support portion 213. The second current collector 311B is an example of the “conductive sheet” in the present disclosure.

The second current collector 311B includes a first conductive layer 413a, a second conductive layer 413b, and a conductive support portion (solid portion) 413c. The conductive support portion 413c includes a one-side surface 413d on one side in the thickness direction DT and the other-side surface 413e on the other side in the thickness direction DT. The first conductive layer 413a and the second conductive layer 413b are formed on the one-side surface 413d and the other-side surface 413e, respectively. The conductive support portion 413c is an example of the “solid portion” in the present disclosure.

A bubble Bu is formed in each of the first conductive layer 413a and the second conductive layer 413b. That is, the first conductive layer 413a and the second conductive layer 413b each have a porous portion (first porous portion) 413f and a porous portion (second porous portion) 413g. The conductive support portion 413c is a solid portion in which no bubble is formed. The porous portion 413f and the porous portion 413g are examples of the “first porous portion” and the “second porous portion” in the present disclosure, respectively.

Thus, the first conductive layer 413a (porous portion 413f) and the second conductive layer 413b (porous portion 413g) in which the bubbles Bu are formed can be disposed closer to the second active material layer 12B than the solid conductive support portion 413c. As a result, the electrolytic solution held in the bubbles Bu of the first conductive layer 413a and the second conductive layer 413b can easily permeate the second active material layer 12B. In addition, since the porous portion is disposed in the vicinity of the second active material layer 12B, it is possible to suppress the electrolyte solution from being insufficient (drying up) in the second active material layer 12B.

As illustrated in FIG. 13, each of the first conductive layer 413a and the second conductive layer 413b is in contact with each of the conductive support portion 413 and the second active material layer 12B. In other words, each of the first conductive layer 413a and the second conductive layer 413b is placed between the conductive support portion 413 and the second active material layer 12B in the thickness direction DT.

The density of the bubbles Bu in each of the first conductive layer 413a and the second conductive layer 413b may be uniform. The density of the bubbles Bu in each of the first conductive layer 413a and the second conductive layer 413b may be, for example, higher toward the second active material layer 12B.

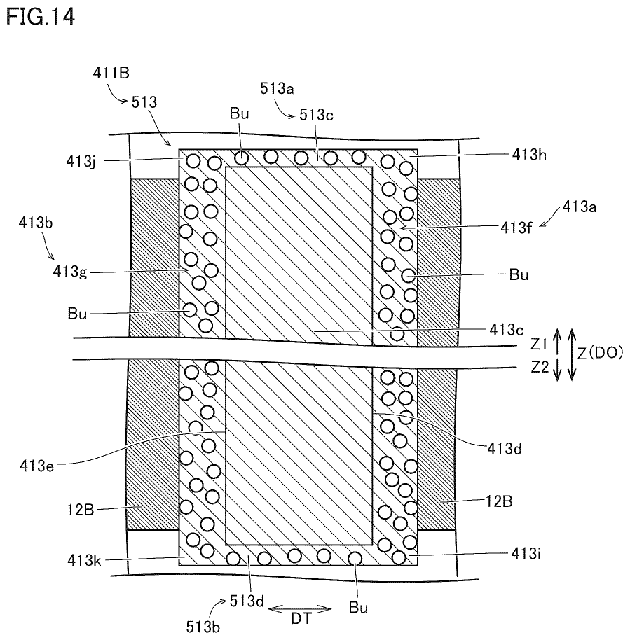

FIG. 14 is a cross-sectional view of a second current collector (conductive sheet) 411B which is a modification of the second current collector 311B of FIG. 13. The second current collector 411B includes a conductive support portion 513. The second current collector 411B is an example of the “conductive sheet” in the present disclosure.

The conductive support portion 513 is different from the conductive support portion 413 in FIG. 13 in that it includes a connection portion 513a and a connection portion 513b.

The first conductive layer 413a (porous portion 413f) includes an end portion 413h on the Z1 side and an end portion 413i on the Z2 side. The second conductive layer 413b (porous portion 413g) includes an end portion 413j on the Z1 side and an end portion 413k on the Z2 side. The connection portion 513a connects the end portion 413h and the end portion 413j. The connection portion 513b connects the end portion 413i and the end portion 413k.

Each of the connection portion 513a and the connection portion 513b has a porous portion 513c and a porous portion 513d in each of which a bubble Bu is formed. Each of the connection portion 513a and the connection portion 513b is formed integrally with each of the first conductive layer 413a and the second conductive layer 413b. The connection portion 513a and the connection portion 513b are in contact with an end portion of the conductive support portion 413c on the Z1 side and an end portion of the conductive support portion 413c on the Z2 side, respectively.

With the configuration as shown in FIG. 14, separation of the porous portion 413f and the porous portion 413g can be suppressed by connecting the porous portion 413f and the porous portion 413g while disposing the porous portion 413f and the porous portion 413g in the vicinity of the second active material layer 12B.

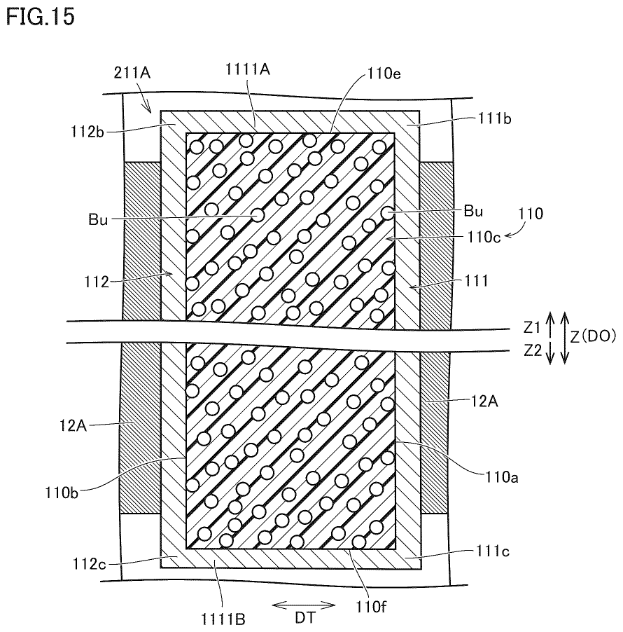

In addition, each modification of FIGS. 12 to 14 may be applied to the first current collector 11A (FIG. 9) of the above embodiment. For example, FIG. 15 is a cross-sectional view illustrating a configuration of a first current collector (conductive sheet) 211A in which the modification of FIG. 12 is applied to the first current collector 11A. The first current collector 211A is an example of the “conductive sheet” in the present disclosure.

The first current collector 211A is different from the first current collector 11A in that it includes a connection portion (third solid portion) (solid portion) 1111A and a connection portion (third solid portion) (solid portion) 1111B.

The first conductive layer 111 includes an end portion (first end portion) 111b on the Z1 side and an end portion (first end portion) 111c on the Z2 side. The second conductive layer 112 includes an end portion (second end portion) 112b on the Z1 side and an end portion (second end portion) 112c on the Z2 side. The end portion 111b and the end portion 112b are connected by a connection portion 1111A. The end portion 111c and the end portion 112c are connected by a connection portion 1111B. Each of the connection portion 1111A and the connection portion 1111B is solid without bubbles. The connection portion 1111A and the connection portion 1111B are formed integrally with the first conductive layer 111 and the second conductive layer 112, respectively. Each of the end portion 111b and the end portion 111c is an example of the “first end portion” in the present disclosure. Each of the end portion 112b and the end portion 112c is an example of the “second end portion” of the present disclosure. Each of the connection portion 1111A and the connection portion 1111B is an example of the “third solid portion” and the “solid portion” of the present disclosure.

Thus, the first conductive layer 111 and the second conductive layer 112 can be electrically connected to each other by the connection portion 1111A (1111B). As a result, even when the second foil portion 92 (FIG. 5) is omitted, the first conductive layer 111 and the second conductive layer 112 can be electrically connected to the first coupling member 50A (FIG. 5).

In the configuration in which the modifications of FIGS. 13 and 14 are applied to the first current collector 11A, bubbles are formed in the first conductive layer and the second conductive layer, and the insulating support layer is solidly formed. These are not shown.

In the above embodiment, an example in which the porous portion in which the bubble Bu is formed is provided in each of the first current collector 11A and the second current collector 11B has been described, but the present disclosure is not limited thereto. The porous portion may be formed in only one of the first current collector 11A and the second current collector 11B.

In the above embodiment, in the first current collector 11A, an example in which the bubble Bu is formed in the insulating support layer 110 and the bubble Bu is not formed in the first conductive layer 111 and the second conductive layer 112 has been described, but the present disclosure is not limited thereto. In addition to the insulating support layer 110, a bubble Bu may also be formed in at least one of the first conductive layer 111 and the second conductive layer 112.

Although the porous portion and the solid portion are stacked in the above-described embodiment and modification, the present disclosure is not limited thereto. Instead of the solid portion, a porous portion in which the density of the bubbles Bu is lower than that of the porous portion may be provided.

In the above embodiment, the porous portion extends without interruption in the extending direction, but the present disclosure is not limited thereto. For example, the porous portion may be provided intermittently in the extending direction. Further, the porous portion may be provided at only one position in the extending direction.

Although an example in which the porous portion is formed by forming the bubble Bu has been described in the above embodiment, the present disclosure is not limited thereto. For example, the porous portion may be formed by forming a hole portion (through hole) extending in the thickness direction DT.

The configurations of the above embodiments and modifications may be combined with each other.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell that is a secondary battery, the power storage cell comprising:
a first electrode sheet;
a second electrode sheet stacked on the first electrode sheet; and
a separator placed between the first electrode sheet and the second electrode sheet, wherein
at least one of the first electrode sheet and the second electrode sheet includes:
a conductive sheet; and
an electrode active material layer formed on the conductive sheet, and
the conductive sheet includes a porous portion having a porous structure.

2. The power storage cell according to claim 1, wherein
a multilayer sheet including the first electrode sheet, the separator, and the second electrode sheet, is formed to surround a winding axis,
in a state where the multilayer sheet is wound, the multilayer sheet extends from an inner end to an outer end of the multilayer sheet in an extending direction, and
the porous portion extends in the extending direction.

3. The power storage cell according to claim 2, wherein
the conductive sheet further includes a solid portion stacked on the porous portion,
the porous portion includes:
a first surface; and
a second surface located opposite to the first surface, and
the solid portion includes:
a first solid portion formed on the first surface; and
a second solid portion formed on the second surface.

4. The power storage cell according to claim 3, wherein
the porous portion and the solid portion are stacked in a stacking direction, and a direction crossing the stacking direction is a crossing direction,
the first solid portion includes a first end portion on one side in the crossing direction,
the second solid portion includes a second end portion on the one side in the crossing direction, and
the solid portion further includes a third solid portion connecting the first end portion and the second end portion to each other.

5. The power storage cell according to claim 2, wherein
the conductive sheet further includes a solid portion stacked on the porous portion,
the solid portion includes:
a one-side surface; and
an other-side surface located opposite to the one-side surface, and
the porous portion includes:
a first porous portion formed on the one-side surface; and
a second porous portion formed on the other-side surface.
